(19) United States
(12) Patent Application Publication
(10) Pub. No.: US 2005/0144411 A1
(43) Pub. Date: Jun. 30, 2005

(54) Partitioning memory

(76) Inventor: David Qiang Meng, Union City, CA (US)

Correspondence Address: FISH & RICHARDSON, PC, 12390 EL CAMINO REAL, SAN DIEGO, CA, 92130-2081, US

(21) Appl. No.: 10/750,423

(22) Filed: Dec. 30, 2003

(51) Int. Cl. G06F 12/00

(52) U.S. Cl. 711/170; 711/168; 711/108

(57) ABSTRACT

A method includes partitioning a memory device to produce a first group of memory entries being accessible in parallel and selectable independent of a second group of memory entries in the memory device that is accessible in parallel.

### BACKGROUND

Networks are used to distribute information among computer systems by sending the information in segments such as packets. A packet typically includes a “header” directs the packet through the network to a destination, and a “payload” that stores a segment of information being sent through the network. At particular locations in the network, the packet header is accessed to identify the packet's destination and determine the path in the network to send the packet. To determine the path, data in the packet's header is compared to data stored at the network location for a potential match. By matching the header data and the locally stored data, an appropriate path is identified and the packet is sent over the path for delivery to its destination.

### DESCRIPTION OF DRAWINGS

FIG. 1 is a block diagram depicting a system for forwarding packets.

FIG. 2 is a block diagram depicting portions of a network processor.

FIG. 3 is a block diagram depicting portions of a packet engine.

FIG. 4 is a block diagram depicting a configuration of a content-addressable memory (CAM).

FIG. 5 is a block diagram depicting another CAM configuration.

FIG. 6 is a block diagram depicting another CAM configuration.

FIG. 7 is a block diagram depicting another CAM configuration.

FIG. 8 is a flow chart of a portion of a CAM manager.

FIG. 9 is a flow chart of another portion of a CAM manager.

### DESCRIPTION

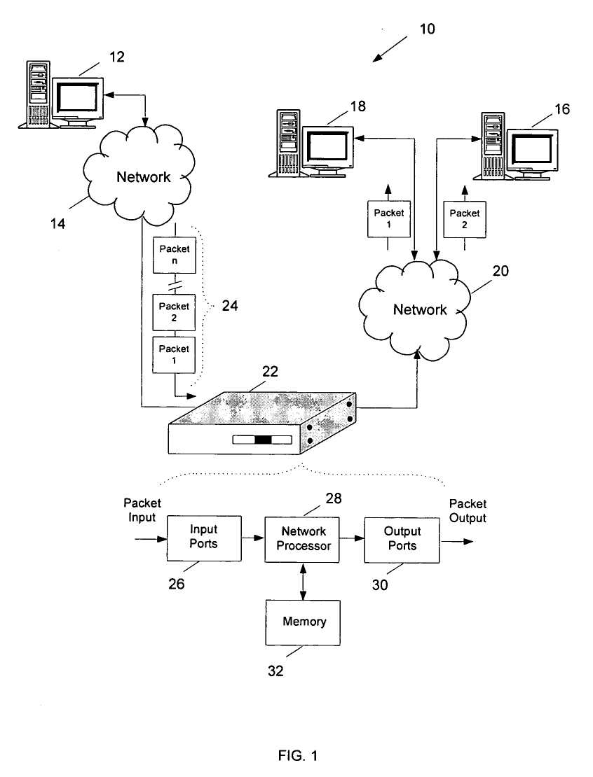

Referring to FIG. 1, a system 10 for transmitting packets from a computer system 12 through a network 14 (e.g., a local area network (LAN), a wide area network (WAN), the Internet, etc.) to other computer systems 16, 18 by way of another network 20 includes a router 22 that collects a stream of “n” packets 24 and schedules delivery to the appropriate destinations of the individual packets as provided by information included in the packets. For example, information stored in the “header” of packet_1 is used by router 22 to send the packet through network 20 to computer system 18 while “header” information stored in packet_2 is used to send packet_2 to computer system 16.

Typically, the packets are received by the router 22 on one or more input ports 26 that provide a physical link to network 14. The input ports 26 are in communication with a network processor 28 that controls the entering of the incoming packets. The network processor 28 also communicates with router output ports 30, which are used for scheduling transmission of the packets through network 20 for delivery at one or more appropriate destinations (e.g., computer systems 16, 18). In this particular example, router 22 uses the network processor 28 to send the stream of “n” packets 24, however, in other arrangements a hub, network switch, or other similar packet-forwarding device that includes a network processor is used to transmit the packets.

Typically, as the packets are received, the router 22 stores the packets in a memory 32 (e.g., random access memory (RAM), read-only memory (ROM), dynamic RAM (DRAM), static RAM (SRAM), etc.) that is in communication with the network processor 28. By storing the packets in memory 32, the network processor 28 accesses the memory to retrieve one or more packets, for example, to verify if a packet has been lost in transmission through network 14, or to determine packet destinations, or to perform other operations. However, in some arrangements, one or more of the packets are stored separately in a storage device (e.g., a hard drive, CR-ROM, etc.) that is in communication with network processor 28.

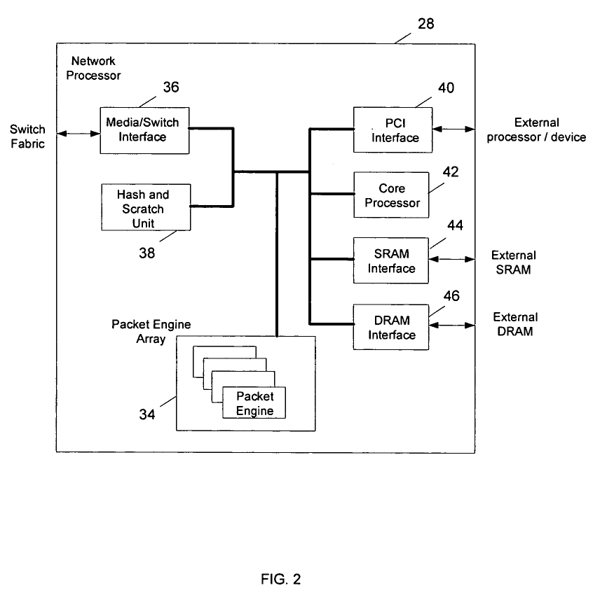

Referring to FIG. 2, network processor 28 is depicted to include features of an Intel® Internet exchange network processor (IXP). However, in some arrangements network processor 28 incorporates other packet processor designs. This exemplary network processor 28 includes an array of packet engines 34 in which each engine provides multi-threading capability for executing instructions from an instruction set such as a reduced instruction set computing (RISC) architecture. For example, for efficient processing RISC instructions may not include floating point instructions or instructions for integer multiplication or division commonly provided by general purpose processors. Furthermore, since the instruction set is designed for specific use by the array of packet engines 34, the instructions are executed relatively quickly, for example, compared to instructions executing on a general-purpose processor.

Each packet engine in the array 34 includes e.g., eight threads that interleave instructions executing thus increasing efficiency and making more productive use of the packet engine resources that might otherwise be idle. In some arrangements, the multi-threading capability of the packet engine array 34 is supported by hardware that reserves different registers for different threads and quickly swaps thread contexts. In addition to accessing shared memory, each packet engine also features local memory and a content-addressable memory (CAM). The packet engines may communicate among each other, for example, by using neighbor registers in communication with an adjacent engine or engines or by using shared memory space.

The network processor 28 also includes a media/switch interface 36 (e.g., a CSIX interface) that sends and receives data to and from devices connected to the network processor such as physical or link layer devices, a switch fabric, or other processors or circuitry. A hash and scratch unit 38 is also included in the network processor 28. The hash function provides, for example, the capability to perform polynomial division (e.g., 48-bit, 64-bit, 128-bit, etc.) in hardware to conserve clock cycles that are typically needed in a software implemented hash function. The hash and scratch unit 38 also includes memory such as static random access memory (SRAM) that provides a scratchpad function while operating relatively quickly compared to SRAM external to network processor 28.

The network processor 28 also includes a interface 40 (e.g., a peripheral component interconnect (PCI) interface) for communicating with another processor such as a microprocessor (e.g. Intel Pentium®, etc.) or to provide an interface to an external device such as a public-key cryptosystem (e.g., a public-key accelerator) to transfer data to and from the network processor 28 or external memory (e.g., SRAM, DRAM, etc.) in communication with the network processor such as memory 32. A core processor 42 such as a StrongARM® processor from ARM Limited of the United Kingdom or an Intel® Xscale® processor is also included in the network processor 28. The core processor 42 typically performs “control plane” tasks and management tasks (e.g., look-up table maintenance). However, in some arrangements the core processor 42 also performs “data plane” tasks, which are typically performed by the packet engine array 34 and may provide additional packet processing threads.

The network processor 28 also includes an SRAM interface 44 that controls read and write access to external SRAMs along with modified read/write operations (e.g., increment, decrement, add, subtract, bit-set, bit-clear, swap, etc.), link-list queue operations, and circular buffer operations. A DRAM interface 46 controls DRAM external to the network processor 28, such as memory 32, by providing hardware interleaving of DRAM address space to prevent extensive use of particular portions of memory.

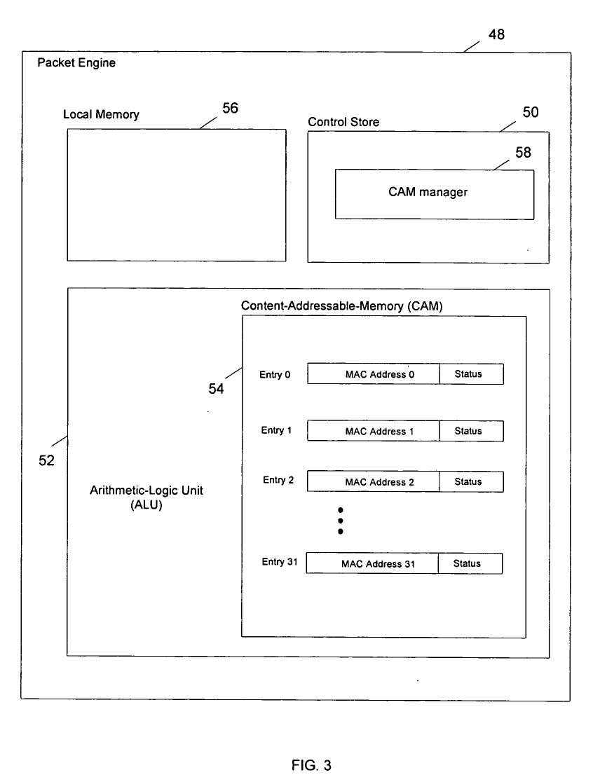

Referring to FIG. 3, a packet engine 48 included in the array of packet engines 34 quickly executes processes such as packet verifying, packet classifying, packet forwarding, and so forth, while leaving more complicated processing to the core processor 40. The packet engine 48 includes multiple threads (e.g., eight threads) that interleave execution of instructions. When a thread is executing instructions, and experiences a break point, i.e., a break in processing that would incur a relatively large latency before resuming execution, such as the need to perform a memory access, another thread included in the packet engine executes instructions to maintain a nearly constant number of instructions executed per second in the packet engine 48.

Instructions executed on packet engine 48 are typically written in microcode. However, in some arrangements, high-level languages such as “C”, “C++”, or other similar computer languages are used to program instructions for execution on packet engine 48. The packet engine 48 includes a control store 50 that stores one or more blocks of microcode instructions, which are referred to as microblocks and are executed on the packet engine 48.

Packet engine 48 also includes an arithmetic-logic unit (ALU) 52 that carries out arithmetic and logic operations as microblock instructions are executed. In some arrangements the ALU 52 is divided into two units, an arithmetic unit (AU) that executes arithmetic operations (e.g., addition, subtraction, etc.) and a logic unit (LU) that executes logical operations (e.g., logical AND, logical OR, etc.).

To execute arithmetic and logic operations, ALU 52 includes a content-addressable memory (CAM) 54 that includes, e.g., thirty-two entries (i.e., entry 0-entry 31) that are capable of being used by the packet engine threads to execute microblocks stored in control store 50. CAM 54 allows the entries to be accessed in parallel so that all or some of the entries can be checked during the same time period (e.g., clock cycle) to determine if particular data is present in one of the entries. For example, to route a received packet (e.g., packet_1) to its intended destination, a destination address stored in the packet is compared in parallel to addresses stored in the CAM 54 entries. If a match is detected, the particular CAM entry storing the matching data is used to identify a corresponding location in local memory 56. For example, if an address (e.g., a media access control (MAC) address) associated with a received packet matches data (e.g., MAC address 0) stored in CAM entry 0, the CAM entry identifies a location in the local memory 56 that stores data (e.g., an Internet Protocol (IP) address) for directing the packet to its intended destination. If a match is not found, appropriate data (e.g., IP address) for directing the packet are retrieved from memory external to the packet engine (e.g., DRAM) and stored in the local memory 56. Also to direct other packets intended for the same destination, the unmatched address (e.g., MAC address) is stored in one of the CAM 54 entries. In some arrangements, the contents of the “Least Recently Used” (LRU) CAM entry is replaced with the unmatched address, however, other arrangements may implement other CAM entry selection techniques.

In this example, each of the thirty-two CAM 54 entries includes a 32-bit portion for storing data (e.g., MAC addresses) for comparing in parallel with other data (e.g., a MAC address associated with a received packet). Additionally, each entry includes a 9-bit portion that stores data that represents detected matches associated with the corresponding 32-bit portion of the entry. However, in other arrangements, each portion includes more or less bits. Furthermore, one or more of the CAM 54 entries may include more or less than two portions.

Each of the entries in CAM 54 is configurable by a CAM manager 58 that is implemented as microcode in the control store 50 and, which is executed by the packet engine 48. The CAM manager 58 partitions the CAM 54 into a particular number of entries. The CAM manager 58 is capable of partitioning individual entries into two or more subentries that are individually selectable for use in parallel comparisons. By producing subentries, particular ones of the subentries are grouped for storing one type of data (e.g. MAC addresses) and selected for use in comparing the data in parallel. Other subentries in the same CAM entries are grouped for storing and comparing another type of data (e.g., IP addresses). Thus, CAM 54 is configured by CAM manager 58 for storing two or more types of data in subentries that are individually selectable for use in parallel comparisons. By configuring CAM 54 for storing and comparing different types of data, the CAM 54 does not need to be loaded at separate instances with different types of data (e.g., MAC addresses, IP addresses) to perform parallel comparisons with different data types. By reducing the number of instances that the CAM entries are loaded, clock cycles are conserved that can be used to execute other operations in packet engine 48 and the network processor 28.

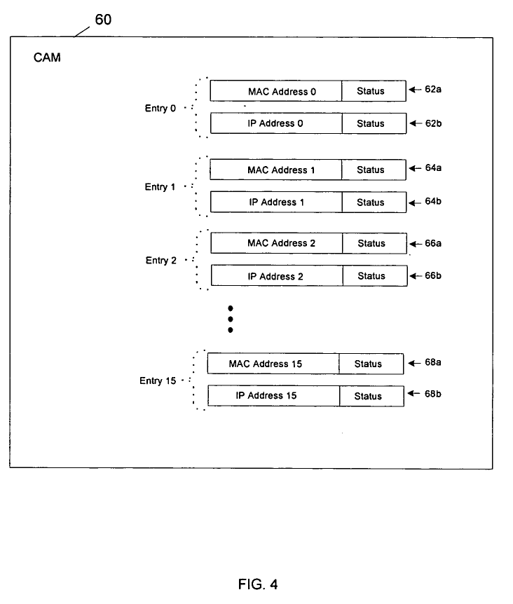

Referring to FIG. 4, CAM 60 represents CAM 54 configured by CAM manager 58 so that each CAM entry (e.g., entry 0-entry 15) includes two subentries that store two different types of data. In this example, one set of sub-entries 62a, 64a, 66a, . . . , 68a store MAC addresses that are used for routing packets through the physical layer of a device connected to router 22. A second set of sub-entries 62b, 64b, 66b, . . . , 68b store Internet protocol (IP) addresses for routing packets on the network layer of the Transmission Control Protocol/Internet (TCP/IP). In this arrangement each sub-entry 62a, 62b-68a, 68b includes a portion that stores an address (e.g., a MAC address or an IP address) that is 32-bits in length and a 9-bit portion that stores status data representing if the stored address has been matched with data from a received packet (e.g., packet_1).

By configuring CAM 60 so that each entry includes two 41-bit subentries (e.g., 32-bit address portion plus 9-bit status portion) that store different data types, CAM manager 58 loads appropriate addresses in each entry and selects which set of subentries to compare in parallel with other data (e.g., received packet data) to detect a potential match. For example, CAM manager 58 selects subentries 60a, 62a, 64a, . . . , 66a to compare each MAC address stored in the subentries with a MAC address retrieved from a packet received by router 22. Similarly, the CAM manager 58 can select subentries 60b, 62b, 64b, . . . , 66b to compare the sixteen IP addresses respectively stored in the group of subentries with an IP address associated with a received packet. By allowing CAM 54 to load different data types (e.g., MAC addresses, IP addresses) into each CAM entry and to select which data type to use to determine a potential match, the CAM can be loaded during one time period with two or more different data types compared to loading the CAM multiple times with different data types for separate parallel comparisons in an un-configurable CAM. Thus, by loading two different data types during the same time period, loading time is reduced by about half. By reducing loading time, conserved clock cycles can be used to perform other operations in the packet engine 48. Along with partitioning CAM 60 into sixteen entries that each include two sub-entries, CAM manager 58 can configure the CAM to include more or less entries and subentries.

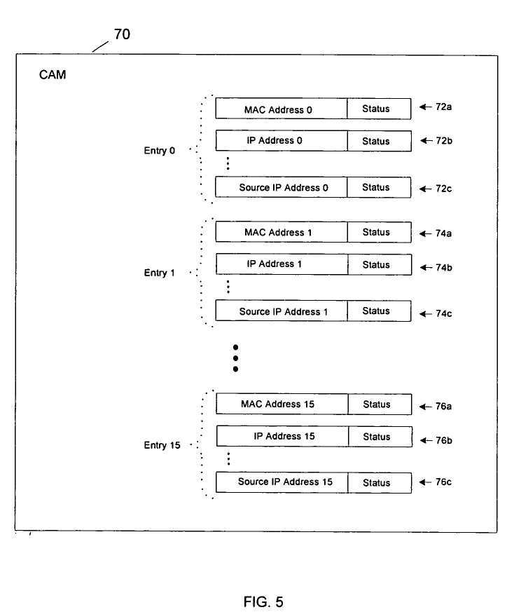

Referring to FIG. 5, CAM 70 represents CAM manager 58 partitioning CAM 54 so that each entry includes “n” subentries that are selectable for parallel comparisons with data, for example, retrieved from a received packet. In this example, respective subentries 72a, 74a, . . . , 76a in the entries store a MAC address (e.g., MAC address 0, MAC address 1, etc.), while other respective subentries 72b, 74b, . . . , 76b in the entries store an IP address (e.g., IP address 0, IP address 1, etc.) and still other subentries 72c, 74c, . . . , 76c store source IP addresses. However, the subentries can also store other types of information such as input port and output port information. Similar to CAM 60 (shown in FIG. 4), the CAM manager 58 selects one group of the subentries for use in a parallel comparison. For example, CAM manager 58 selects sub-entries 72a, 74a, . . . , 76a to compare each of the MAC addresses to an address associated with a received packet. Along with configuring the number of sub-entries in each CAM entry, the CAM manager 58 is capable of partitioning the individual subentries included in a CAM entry.

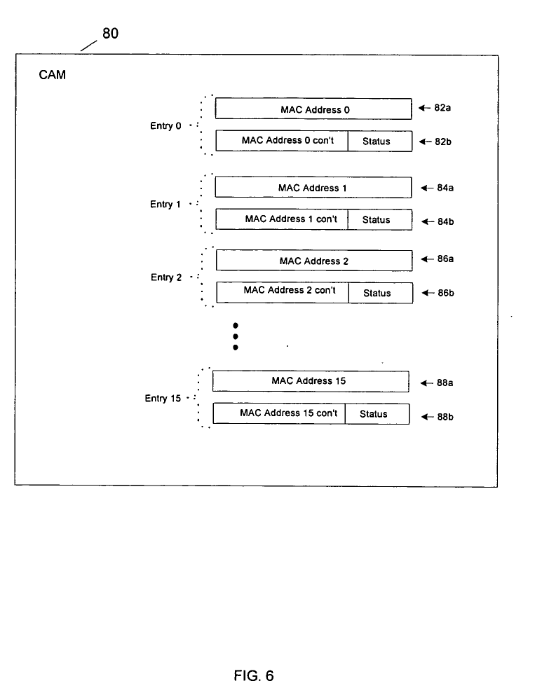

Referring to FIG. 6, similar to CAM 60 (shown in FIG. 4) and CAM 70 (shown in FIG. 5), CAM 80 represents CAM manager 58 partitioning CAM 54 to include sixteen entries (e.g., entry 0-entry 15). However, each of the entries includes one extended subentry that is the combination of two subentries. In this example, since each of the two subentries is 41-bits long (e.g., 32 bits for storing an address+9 bits storing status), each entry includes an 82-bit long subentry.

By combining two subentries, each entry is capable of storing data in more bits than provided by a smaller single subentry (e.g., 41 bits). For example, in entry 0, subentries 82a and 82b are combined to store a single address (e.g., MAC address 0) and status data. Similarly, entries 1 through 15 combine two respective subentries 84a and 84b, 86a and 86b, and subentries 88a and 88b. In this example, each of the CAM entries 0-15 include a combination of two subentries, however, other arrangements some of the CAM entries include combined subentries while other CAM entries include a single subentry or multiple subentries.

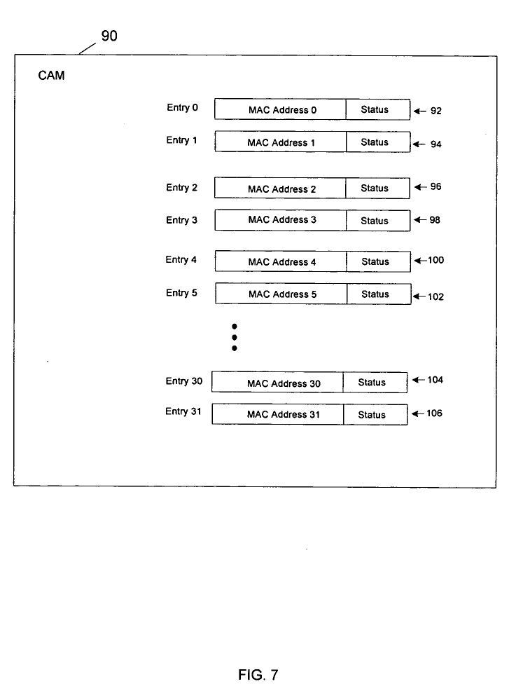

Referring to FIG. 7, CAM 90 represents CAM manager 58 partitioning CAM 54 so that each entry includes one subentry. For example, entry 0 includes a single subentry 92 that includes a 32-bit portion that stores an address (e.g., MAC address 0) and a 9-bit portion that stores the status of the entry in regards to the number of matching hits and misses. Similarly, entries 1-31 respectively include a single subentry 94-106 that each include a 32-bit portion for storing data (e.g., MAC addresses) and a 9-bit portion for storing data representing matching hits and misses. By including a single subentry in each of the thirty-two entries, CAM manager 58 increases the number of MAC addresses, or other type of data that are compared in parallel to a MAC address associated with a received packet or other data received by the packet engine 48. Also, while each subentry includes a 32-bit portion for storing data (e.g., a MAC address) and a 9-bit portion for storing data representing status (e.g., matching status) of the subentry, in other arrangements, each subentry or subentry portion includes more or less bits. Furthermore, while this example includes thirty-one entries, in other arrangements CAM 90 includes more or less entries.

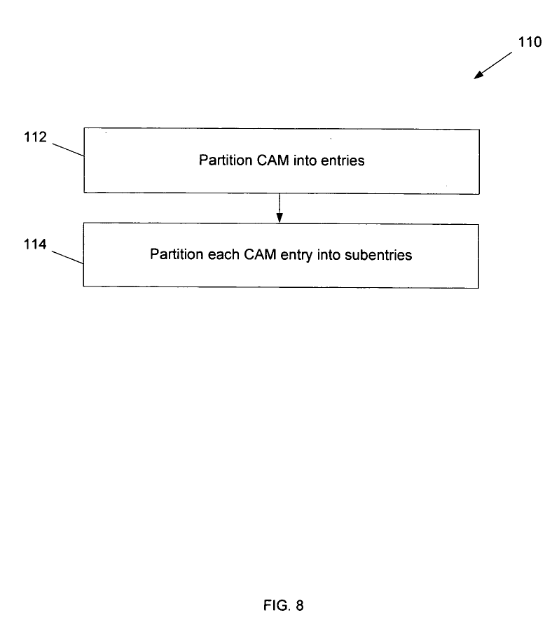

Referring to FIG. 8, a portion of a CAM manager 110, such as CAM manager 58 stored in control store 50 and executed in the packet engine 48 partitions 112 a CAM into a particular number of entries. For example, CAM 60 (shown in FIG. 4), CAM 70 (shown in FIG. 5), and CAM 80 (shown in FIG. 6) are partitioned by CAM manager 58 into sixteen entries while CAM 90 (shown in FIG. 7) is partitioned into thirty-two entries. The CAM manager 110 also partitions 114 each CAM entry into subentries. For example, each entry in CAM 60 (shown in FIG. 4) is partitioned to include two subentries. By including two subentries in each CAM entry, one group of the subentries, which store one type of data, can be selected for performing a parallel comparison and a second group of subentries, which store a different type of data, can be selected for a second parallel comparison. Furthermore, besides partitioning each entry to include two subentries, CAM manager 110 partitions each entry to include more than two subentries. For example, each entry (e.g., entries 0-15) in CAM 70 (shown in FIG. 5) is partitioned to include “n” subentries. In another example, each entry is partitioned by the CAM manager 110 to include a single subentry that is a combination of two or more smaller subentries. For example, each entry in CAM 80 (shown in FIG. 6) includes a combination of two subentries to produce one larger subentry.

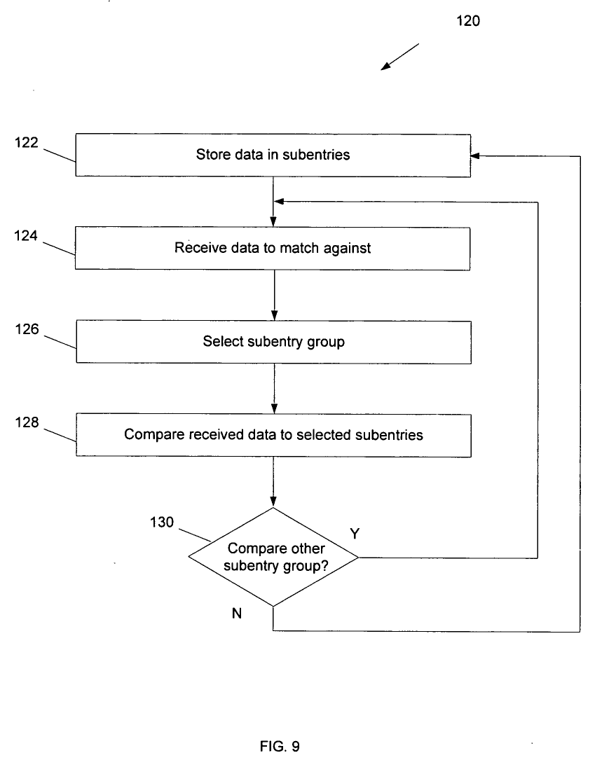

Referring to FIG. 9, another portion of a CAM manager 120, such as CAM manager 58 that is executed in packet engine 48, stores 122 data in subentries included in one or more entries of a CAM. For example, the CAM manager 120 stores different types of data in groups of subentries during one time period. The CAM manager 120 receives 124 data for comparing against a portion of the data stored in the CAM to detect one or more matches. For example, a MAC address associated with a received packet can be compared against a group of MAC addresses respectively stored in a group of subentries.

CAM manager 120 selects 126 the particular group of subentries to compare to the received data. For example, the group of subentries storing MAC addresses is selected to compare, in parallel, to a MAC address associated with a received packet. After selecting the group of subentries to use in the comparison, the CAM manager 120 compares 128, in parallel, the received data to the data stored in the selected group of subentries.

In some arrangements, if a match is detected during the comparison, data is retrieved from a memory, such as local memory 56 for comparing against other data currently stored in the CAM. Based on the comparison, the CAM manager 120 determines 130 whether to compare data retrieved from the local memory, or other data, to another group of subentries. For example, after comparing MAC addresses stored in one group of CAM subentries, the CAM manager 120 determines to perform a parallel comparison of IP addresses stored in another group of subentries included in the CAM. If data is to be compared to another group of subentries, the CAM manager 120 returns to receive data, for example from local memory 56, and selects the group of subentries for the next comparison. If the current data stored in the subentries is not needed for another comparison, the CAM manager 120 returns to store data in the subentries for the next comparison or set of comparisons.

Particular embodiments have been described, however other embodiments are within the scope of the following claims. For example, the operations of the CAM manager 58 can be performed in a different order and still achieve desirable results.

1. A method comprising:
partitioning a memory device to produce a first group of memory entries being accessible in parallel and selectable independent of a second group of memory entries in the memory device that is accessible in parallel.

2. The method of claim 1, further comprising:
partitioning a memory entry in the first group of memory entries into sub-entries.

3. The method of claim 1, further comprising:
selecting the first group of memory entries for accessing in parallel.

4. The method of claim 1 wherein the memory device is included in a multithreaded engine of a packet processor.

5. The method of claim 1 wherein the first group of memory entries store a first type of data and the second group of memory entries store a second type of data.

6. The method of claim 2 wherein the memory entry includes at least two subentries.

7. The method of claim 2 wherein the memory entry includes a combination of subentries.

8. A computer program product, tangibly embodied in an information carrier, the computer program product being operable to cause a machine to:
partition a memory device to produce a first group of memory entries being accessible in parallel and selectable independent of a second group of memory entries in the memory device that is accessible in parallel.

9. The computer program product of claim 8 being further operable to cause a machine to:
partition a memory entry in the first group of memory entries into sub-entries.

10. The computer program product of claim 8 being further operable to cause a machine to:
select the first group of memory entries for accessing in parallel.

11. A computer program product of claim 8 wherein the memory device is included in a multithreaded engine of a packet processor.

12. The computer program product of claim 8 wherein the first group of memory entries store a first type of data and the second group of memory entries store a second type of data.

13. The computer program product of claim 9 wherein the memory entry includes at least two subentries.

14. The computer program product of claim 9 wherein the memory entry includes a combination of subentries.

15. A content-addressable memory (CAM) manager comprises:
a process to partition a memory device to produce a first group of memory entries being accessible in parallel and selectable independent of a second group of memory entries in the memory device that is accessible in parallel.

16. The CAM manager of claim 15 further comprising:
a process to partition a memory entry in the first group of memory entries into sub-entries.

17. The CAM manager of claim 15 further comprising:
a process to select the first group of memory entries for accessing in parallel.

18. A system comprising:
a memory device capable of being partitioned to produce a first group of memory entries that is accessible in parallel and selectable independent of a second group of memory entries in the memory device that is accessible in parallel.

19. The system of claim 18 wherein a memory entry in the first group of memory entries is capable of being partitioned into sub-entries.

20. The system of claim 18 wherein the first group of memory entries is further capable of being selected for accessing in parallel.

21. A packet forwarding device comprising:
an input port for receiving a packet;
and output port for delivering the received packet; and
a memory device capable of being partitioned to produce a first group of memory entries that is accessible in parallel and selectable independent of a second group of memory entries in the memory device that is accessible in parallel.

22. The packet forwarding device of claim 21 wherein a memory entry in the first group of memory entries is capable of being partitioned into sub-entries.

23. The packet forwarding device of claim 21 wherein the first group of memory entries is further capable of being selected for accessing in parallel.

24. A content-addressable memory (CAM) comprising:
a first group of memory entries being accessible in parallel and selectable independent of a second group of memory entries in the CAM that is accessible in parallel.

25. The CAM of claim 24 wherein a memory entry in the first group of memory entries is capable of being partitioned into sub-entries.

26. The CAM of claim 24 wherein the first group of memory entries is further capable of being selected for accessing in parallel.
